(19) United States
(12) Patent Application Publication
(10) Pub. No.: US 2007/0072991 A1
(43) Pub. Date: Mar. 29, 2007

(54) Synthesis of thermoplastic polyurethane composites

(75) Inventors: Sadha Chandra Jana, Fairlawn, OH (US); Asim Pattanayak, Bangalore (IN)

Correspondence Address: ROETZEL AND ANDRESS, 222 SOUTH MAIN STREET, AKRON, OH, 44308, US

(73) Assignee: University of Akron, Akron, OH (US)

(21) Appl. No.: 11/168,222

(22) Filed: Jun. 28, 2005

Related U.S. Application Data
(60) Provisional application No. 60/583,412, filed on Jun. 28, 2004.

(51) Int. Cl. C08G 18/08

(52) U.S. Cl. 524/589

(57) ABSTRACT

The present invention relates to nanocomposites and methods to produce nanocomposites. More particularly, the present invention relates to nanocomposites of thermoplastic polyurethanes that include one or more nanoparticles therein, and to methods to produce such nanocomposites. In one embodiment, the present invention relates to polyurethane nanocomposites wherein organoclay particles are tethered to the polyurethane. In one embodiment, a polymer-particle composite comprising: at least one polyurethane polymer; and particles of at least one modified and/or functionalized compound, wherein the particles of at least one modified and/or functionalized compound contain at least one site that will react with one or more isocyanate groups contained in the polyurethane polymer, and wherein the particles of at least one modified and/or functionalized compound become tethered to one or more isocyanate groups of the polyurethane polymer thereby yielding the polymer-particle composite.

### RELATED APPLICATION DATA

This application claims priority to previously filed U.S. Provisional Application No. 60/583,412, filed on Jun. 28, 2004, entitled “Synthesis of Thermoplastic Polyurethane Nanocomposites,” which is hereby incorporated by reference in its entirety.

### FIELD OF THE INVENTION

The present invention relates to nanocomposites and methods to produce nanocomposites. More particularly, the present invention relates to nanocomposites of thermoplastic polyurethanes that include one or more nanoparticles therein, and to methods to produce such nanocomposites. In one embodiment, the present invention relates to polyurethane nanocomposites wherein organoclay particles are tethered to the polyurethane.

### BACKGROUND OF THE INVENTION

As is known in the art, polyurethanes have widespread applications as coatings, adhesives, foams, rubbers, and thermoplastic elastomers. Often a library of raw material systems is called upon, usually by heuristics, to design specific polyurethane products. The advent of polymer nanotechnology can be utilized in these circumstances to obtain a variety of properties from the same set of organic raw materials through introduction of nanoscopic filler particles, such as layered silicates and carbon nanotubes and nanofibers, often with the possibility of polymer chain-nanoparticle reactions. The type of nanofillers and their state and degree of dispersion can be manipulated to obtain an array of properties not presently achievable from polyurethanes or polyurethanes filled with micrometer size inorganic filler particles. Incidentally, small quantities of nanofillers, in the range of 3 to 5 percent by weight, can prove to be sufficient enough to bring out enormous enhancement in certain physical and/or mechanical properties, thereby reducing the cost and causing a drop in the weight of finished articles in comparison to similar articles made from conventional microcomposites that contain silica or talc.

Examples of polymer-organoclay composites include U.S. Pat. No. 5,421,876 to Janoski, that relates to a organoclay-filled asphaltic polyurethane; U.S. Pat. No. 6,533,975 to Kosinski et al., that relates to a fiber or film formed from polyurethane and delaminated layers made from a lamellar clay, that are dispersed in the polyurethane; and U.S. Pat. No. 6,380,295 to Ross et al., relates to an organic chemical/phyllosilicate clay intercalate that can be used as an ion-exchange medium with quaternary ammonium compounds and is useful in forming nanocomposites using polyurethanes. Other examples included U.S. Pat. No. 5,962,553 to Ellsworth relates to a nanocomposite made by melt-blending a melt processable polymer, such as a polytetrafluoroethylene, and an organophosphonium modified layered clay.

The results reported to date on polymer nanocomposites, including polyurethane nanocomposites, highlight dramatic increases in tensile modulus, accompanied often by increases in tensile strength and reduced elongation. Increases in stiffness and strength were first demonstrated in polyamide-clay nanocomposites. These composites showed as much as 100% increase in stiffness and 50% increase in strength with only a 4 weight percent nanoclay loading. Others have shown large enhancements in tensile strength and tensile modulus in intercalated composites of organically treated nanoclay and polyurethanes (see Wang and Pinnavaia, Chem. Mater., Vol. 10, 1998, pp. 3769 to 3771). Subsequent studies also observed intercalated clay tactoids in polyurethane-nanoclay composites and reported enhancement in tensile strength, modulus, and elongation at break.

Despite providing improved understanding of polymer nanocomposites, a majority of prior work on polymer nanocomposites, and in particular polyurethane nanocomposites, has limited industrial applicability due to the use of solvents. Although solvents eliminate diffusional limitations and provide isothermal conditions during a reaction, they must be removed from the final product (e.g., the solvents can be removed and recycled for further use). Thus, there is a need in the art for a production method for polymer nanocomposites that reduces and/or eliminates the need for solvents and/or solvent removal.

One method by which to produce polymer nanocomposites is bulk polymerization. However, it is worthy to note that in bulk polymerization system, the diffusion of —NCO groups to the site of intragallery polyol —OH groups will be significantly slow. Some recent studies used bulk polymerization methods and reported results similar to those using solvents.

Although bulk polymerization methods are attractive for industrial production, many relevant issues need to be resolved. First, diffusional limitations are inherently present in bulk polymerization, which can hinder the rates of polymerization and clay-tethering reactions and can have strong effects on the resultant material properties. Second, reaction conditions are rarely isothermal in bulk polymerization and the need for increased reaction temperatures can trigger many side reactions (e.g., the formation of biurets and allophanates). Thus, there is a need in the art for a method to produce polymer nanocomposites that overcomes the afore-mentioned drawbacks.

### SUMMARY OF THE INVENTION

The present invention relates to nanocomposites and methods to produce nanocomposites. More particularly, the present invention relates to nanocomposites of thermoplastic polyurethanes that include one or more nanoparticles therein, and to methods to produce such nanocomposites. In one embodiment, the present invention relates to polyurethane nanocomposites wherein organoclay particles are tethered to the polyurethane.

In one embodiment, the present invention relates to a process for producing a polymer-particle composite, comprising the steps of: (A) preparing a polyurethane polymer; and (B) mixing the polyurethane polymer with particles of at least one modified and/or functionalized compound, wherein the at least one modified and/or functionalized compound contains at least one site that will react with one or more isocyanate groups contained in the polyurethane polymer, and wherein particles of the at least one modified and/or functionalized compound become tethered to one or more isocyanate groups of the polyurethane polymer thereby yielding a polymer-particle composite.

In another embodiment, the present invention relates to a process for producing a polymer-clay composite, comprising the steps of: (A) preparing a polyurethane polymer; and (B) mixing the polyurethane polymer with particles of at least one organically modified clay, wherein the at least one organically modified clay contains at least one site that will react with one or more isocyanate groups contained in the polyurethane polymer, and wherein particles of the at least one organically modified clay become tethered to one or more isocyanate groups of the polyurethane polymer thereby yielding a polymer-clay composite.

In yet another embodiment, the present invention relates to a polymer-particle composite comprising: at least one polyurethane polymer; and particles of at least one modified and/or functionalized compound, wherein the particles of at least one modified and/or functionalized compound contain at least one site that will react with one or more isocyanate groups contained in the polyurethane polymer, and wherein the particles of at least one modified and/or functionalized compound become tethered to one or more isocyanate groups of the polyurethane polymer thereby yielding the polymer-particle composite.

In still another embodiment, the present invention relates to a polymer-clay composite comprising: at least one polyurethane polymer; and at least one organically modified clay composition, wherein the at least one organically modified clay composition contains at least one site that will react with one or more isocyanate groups contained in the polyurethane polymer, and wherein the at least one organically modified clay composition becomes tethered to one or more isocyanate groups of the polyurethane polymer thereby yielding the polymer-clay composite.

### BRIEF DESCRIPTION OF THE DRAWINGS

FIGS. 1(a) to 1(c) are a scanning electron micrographs (SEMs) of Clay 1, Clay 3, and Clay 2, respectively;

FIGS. 2(a) and 2(b) are flow diagrams illustrating two embodiments of a nanocomposite preparation method in accordance with the present invention;

FIG. 3(a) illustrates a WAXD pattern for a polymer-clay composite formed in accordance with a method of the present invention, the polymer-clay composite being formed using Clay 1;

FIG. 3(b) illustrates a WAXD pattern for a polymer-clay composite formed in accordance with a method of the present invention, the polymer-clay composite being formed using Clay 3;

FIG. 3(c) illustrates a WAXD pattern for a polymer-clay composite formed in accordance with a method of the present invention, the polymer-clay composite being formed using Clay 2;

FIGS. 4(a) and 4(b) are TEM images, at low magnification and high magnification, respectively, of a polymer-clay composite formed in accordance with one embodiment of the present invention;

FIG. 5 illustrates a WAXD pattern for a polymer-clay composite formed in accordance with a method of the present invention, the polymer-clay composite being formed using Clay 2;

FIG. 6 is a TEM image of a polymer-clay composite formed in accordance with a method of the present invention, the polymer-clay composite being formed using Clay 2;

FIG. 7(a) is a series of images illustrating the transparency of polymer-clay composites made in accordance with one embodiment of the present invention;

FIG. 7(b) is a series of images illustrating the transparency, or lack thereof, of polymer-clay composites made in accordance with another embodiment of the present invention;

FIG. 8(a) is a graph depicting the conversion (a) of —NCO groups as confirmed by an FT-IR;

FIG. 8(b) is a graph depicting the change in A_{CO} over time;

FIG. 9 depicts the FT-IR spectra of Clays 1, 2, and 3;

FIG. 10 depicts FT-IR spectra of Prepolymer, pristine polyurethane polymer, and various polymer-clay composites formed in accordance with the methods of the present invention;

FIG. 11 depicts carbonyl peaks in the FT-IR spectra of various polymer-clay composites formed in accordance with the methods of the present invention;

FIG. 12 depicts a hydrogen bonding mechanism between clay particles and urethane linkages in the polymer-clay composites according to one embodiment of the present invention;

FIG. 13 depicts FT-IR spectra of Soxhlet extracted residues of polymer-clay composites formed with 5 weight percent clay in accordance with the methods of the present invention;

FIG. 14 depicts DSC thermograms of Soxhlet extracted residues of polymer-clay composites formed with 5 weight percent clay in accordance with the methods of the present invention; and

FIG. 15 depicts polymer-clay tethering by primarily looping chains and coating of clay particles by polymer chains via Method I of the present invention.

### DESCRIPTION OF THE INVENTION

The present invention relates to nanocomposites and methods to produce nanocomposites. More particularly, the present invention relates to nanocomposites of thermoplastic polyurethanes that include one or more nanoparticles therein, and to methods to produce such nanocomposites. In one embodiment, the present invention relates to polyurethane nanocomposites wherein organoclay particles are tethered to the polyurethane.

In one embodiment, the present invention relates to polyurethane nanocomposites that are formed by bulk polymerization reaction between at least one polyurethane and at least one type of clay particles. In this embodiment, the nanocomposites have improved clay-polymer tethering properties and improved dispersion of clay in the nanocomposites.

In another embodiment, the present invention relates to polyurethane nanocomposites that are formed by bulk polymerization reaction between at least one polyurethane and at least one type of organoclay particles. In this embodiment, the nanocomposites have improved organoclay-polymer tethering properties and improved dispersion of the organoclay in the nanocomposites. As used throughout the specification and claims, the term organoclay means a compound derived from at least one organic material and at least one inorganic clay.

In the above embodiments, the polyurethane used therein can be any suitable polyurethane that has —NCO groups available for reaction with at least one clay and/or organoclay to yield tethered clay and/or organo particles. In one embodiment, the polyurethane utilized in the present invention is one that is synthesized from, for example, a polyetherpolyol, an isocyanate, and 1,4-butanediol.

In the above embodiment, the at least one organoclay is any organically-modified clay that will react with the —NCO groups present on the polymer chains of the at least one polyurethane. The organoclay of the present invention can be either a naturally occurring organoclay or a synthetic organoclay.

In one embodiment, the clay and/or organoclay used in the present invention is a nano-sized clay. That is, the diameter or length of the particles of clay and/or organoclay, depending upon particle geometry, used in the present invention ranges from about 1 nanometer to about 20,000 nanometers, or from about 10. nanometers to about 10,000 nanometers, or from about 20 nanometers to about 5,000 nanometers, or from about 30 nanometers to about 2,500 nanometers, or from about 40 nanometers to about 1,000 nanometers, or from about 50 nanometers to about 500 nanometers, or even from about 60 nanometers to about 250 nanometers. The thickness of the particles of clay/organoclay used in the present invention ranges from about 0.1 nanometer to about 5 nanometers, or from about 0.5 nanometers to about 3 nanometers, or even from about 1 nanometer to about 2.5 nanometers. Here and elsewhere in the specification and claims the range and ratio limits may be combined.

In one embodiment, the nanocomposites of the present invention can be made by a bulk polymerization process where the reactive organic clay is admixed into the polyurethane at the tail-end of the polyurethane process. It should be noted however, that the present invention is not limited to only the above-mentioned method of manufacture. Rather, any suitable production method can be utilized that permits the formation of a polymer nanocomposite between at least one clay and/or organoclay and at least one polymer (e.g., at least one polyurethane).

The following specific examples are exemplary in nature and the present invention is not limited thereto.

### EXAMPLES

A thermoplastic polyurethane is synthesized from the combination of a polyetherpolyol (Bayer ARCOL PPG 1025), with weight average molecular weight (Mw) of approximately 1020; diphenylmethane4,4′-diisocyanate (MDI—sold as Bayer Mondur M), having a molecular weight of 250 and a melting point of 39° C.; and 1,4-butanediol (BD—sold by Fisher Scientific). The chain extension reactions between pre-polymer and the 1,4-butanediol is catalyzed by a dibutyltinlaureate catalyst (DABCO 120—available from Aldrich).

One untreated and two organically treated clay particles are utilized in the examples of the present invention. Clay 1 is an untreated natural Montmorillonite clay, Cloisite®NA⁺ available from Southern Clay Products. Clay 1 has a cation exchange capacity of 92.6 meq/100 grams of clay.

Clay 2 is a natural Montmorillonite clay modified with a quaternary ammonium salt, Cloisite®30B available from Southern Clay Products. Clay 2 has a cation exchange capacity of 90.0 meq/100 grams of clay.

Clay 3 is an organically treated clay that is prepared by ion exchange of clay 1 with hexadecylammonium chloride using the process taught in Park et al. (Park, J. H., Jana, S. C., Macromolecules, 2003, 36, pp. 2758-2768). Clay 3 has a cation exchange capacity of 129 meq/100 grams of clay.

Among the three clays discussed above, only Clay 2 is reactive to the isocyanate end groups of the polymer chains used in the present invention to form a polymer nanocomposite. The methyl, tallow, bis-2-hydroxyethyl, quaternary ammonium ions in Clay 2 have a structure as shown below: 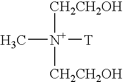
where T (tallow) is an alkyl group with approximately 65% C₁₈H₃₇, 30% C₁₆H₃₃, 5% C₁₄H₂₉, and the anion that is “bound” to the cation is a chloride anion. The —CH₂CH₂OH groups in Clay 2 are capable of reacting with the —NCO groups on the polyurethane polymer chains. Accordingly, Clay 2 can be described as a “reactive organically modified clay,” or a “reactive organic clay” or “organoclay”.

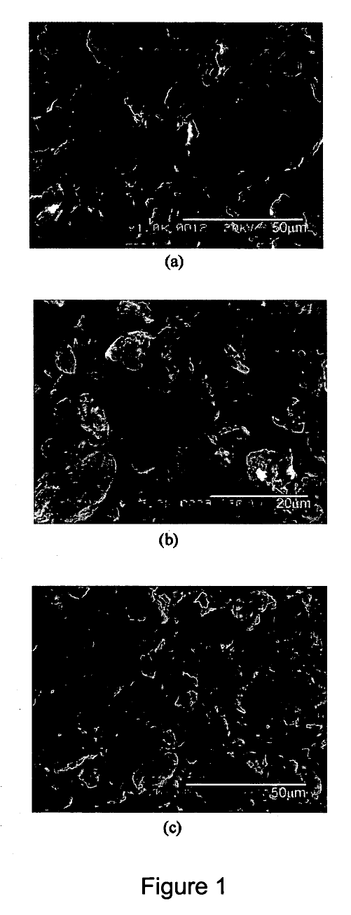

Scanning electron micrographs (SEM) of treated clay specimens in FIG. 1 show particle agglomerates in the size range of about 5 microns to about 20 microns (μm), although individual particles of clay were of 1 nanometer thickness, and had particle sizes within the ranges discussed above. The clay particles contain approximately 2 weight percent moisture, which is removed by drying the clay particles in a vacuum oven at 80° C. for 24 hours. However, upon exposure to a moisture containing atmosphere, the clay particles will reabsorb some moisture (e.g., when the clay is removed from the vacuum oven after drying is complete).

In the case of the above mentioned clays, Clay 1 absorbs approximately 0.23 weight percent moisture when exposed to a moisture laden atmosphere, while Clays 2 and 3 absorb approximately 0.29 weight percent moisture when exposed to a moisture laden atmosphere. A moisture laden atmosphere is hereby defined to be one at standard pressure (approximately 1 atmosphere) and temperature (approximately 25° C.) having a relative humidity of 50%. In the case of Clays 1 to 3, the exposure time to the above-mentioned moisture laden atmosphere is approximately 5 minutes. To avoid significant moisture absorption, dried clay particles should be hand mixed quickly with the other components of the present invention to yield the desired polymer nanocomposites.

TABLE 1

| | Clay Content in | Mole Ratio of |
|---|---|---|
| Material | Weight Percent | MDI/polyol/BD/tallow |
| Pristine Polyurethane | 0 | 2/1/1/0 |
| Clay 1 | 1 | 2/1/1/0 |
| | 3 | 2/1/1/0 |
| | 5 | 2/1/1/0 |
| Clay 2 | 1 | 2/1/0.98/0.02 |
| | 3 | 2/1/0.96/0.04 |
| | 5 | 2/1/0.93/0.07 |
| Clay 3 | 1 | 2/1/1/0 |
| | 3 | 2/1/1/0 |
| | 5 | 2/1/1/0 |

It should be noted, that tallow is only present in the ratios of Clay 2, since only Clay 2 is modified with a quaternary ammonium salt contains tallow.

Table 1 presents molar ratios of various components used in the preparation of polyurethanes with 36% hard segments and its clay composites. The —CH₂CH₂OH groups in Clay 2 are taken into consideration while balancing the ratio of —NCO to —OH groups in the polymer nanocomposites of the present invention. The basis of such calculation is the cation exchange capacity of Clay 2 (that is, 90.0 meq/100 grams of clay). Note that the trace amounts of moisture abosorbed by the clay particles during sample preparation is not considered in balancing the —NCO and —OH groups in Table 1. The amounts of treated clay in the composites is maintained at 1, 3, and 5 weight percent, this translates to 0.76, 2.3, and 3.8 weight percent organic-free clay in Clay 2, and 0.74, 2.2, and 3.7 weight percent organic-free clay in Clay 3. In the remainder of the specification, the clay content will be reported in weight percent of treated clay, which contains both organically treated and organic-free clay particles.

Nanocomposite/Pristine Polyurethane Preparation:

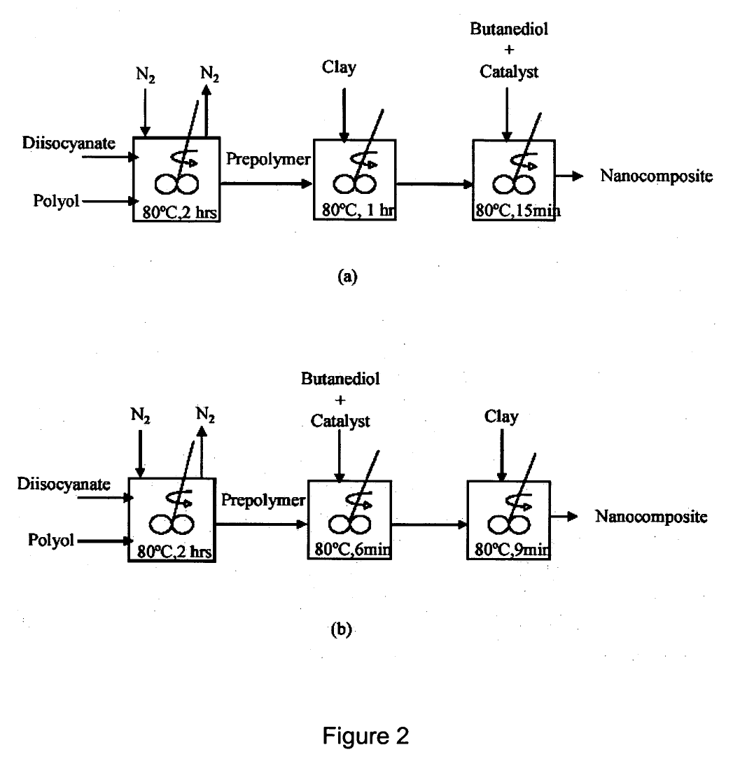

Polyetherpolyol and 1,4-butanediol are dried overnight (i.e., for about 12 hours) in vacuum oven at 50° C. to remove trace moisture. Diphenylmethane4,4′-diisocyanate is dried in vacuum oven at room temperature for approximately one hour to remove any trace moisture. Nanocomposites and pristine polyurethane are prepared by one of two processes, as shown in FIG. 2.

As shown in FIG. 2(a), Method I involves placing diphenylmethane-4,4′-diisocyanate and polyetherpolyol into a mixer, supplying the mixture of diphenylmethane4,4′-diisocyanate and polyetherpolyol under a nitrogen gas sweep, and mixing the contents for two hours at 80° C. in order to facilitate reaction of the diphenylmethane4,4′-diisocyanate with the polyetherpolyol. The temperature is maintained constant at 80° C. using an oil bath. The mixer is a three-neck round bottom flask with a magnetic stirrer. However, any suitable mixing device can be used. As is shown in FIG. 2(a) this yields a Prepolymer.

The Prepolymer is then mixed along with the desired amount of clay or organoclay particles (e.g., Clay 1, Clay 2, Clay 3, or some other suitable clay or organically-modified clay) in a mixer for one hour at 80° C., under a nitrogen sweep. The temperature is maintained constant at 80° C. using an oil bath. The mixer is a three-neck round bottom flask with a magnetic stirrer. However, any suitable mixing device can be used. This yields a Prepolymer/Clay mixture.

Next, chain extension reactions with 1,4-butanediol, catalyzed by dibutyltinlaureate at a concentration of 2.3×10⁻⁷ mol/cm³, are conducted with the Prepolymer/Clay mixture. The Prepolymer/Clay mixture is reacted with the 1,4-butanediol and the dibutyltinlaureate catalyst in a Brabender Plasticorder mixer for 15 minutes. The reaction temperature begins at 80° C. and increases to 120° C. over a three minute period of time due to the exothermic nature of the reaction. The reaction temperature remains at approximately 120° C. for the rest of the period (approximately 12 minutes). Upon completion of this step, a polyurethane nanocomposite is formed.

In Method I, the amount of each reactant is determined by the mole ratios stated in Table 1. The time period of two hours for preparation of the Prepolymer is enough time for complete conversion of —OH groups in the polyetherpolyol. This can be confirmed via titration with dibutylamine. The number (Mn) and weight average (Mw) molecular weight of the Prepolymer is determined by gel permeation chromatography (GPC). Mn is approximately 2800, and Mw is approximately 4300.

As shown in FIG. 2(b), Method II involves placing diphenylmethane-4,4′-diisocyanate and polyetherpolyol into a mixer, supplying the mixture of diphenylmethane-4,4′-diisocyanate and polyetherpolyol under a nitrogen gas sweep, and mixing the contents for two hours at 80° C. in order to facilitate reaction of the diphenylmethane-4,4′-diisocyanate with the polyetherpolyol. The temperature is maintained constant at 80° C. using an oil bath. The mixer is a three-neck round bottom flask with a magnetic stirrer. However, any suitable mixing device can be used. As is shown in FIG. 2(b) this yields a Prepolymer.

Next, chain extension reactions with 1,4-butanediol, catalyzed by dibutyltinlaureate at a concentration of 2.3×10⁻⁷ mol/cm³, are conducted with the Prepolymer. The Prepolymer is reacted with the 1,4-butanediol and the dibutyltinlaureate catalyst in a Brabender Plasticorder mixer for 6 minutes. The reaction temperature begins at 80° C. and increases to 130° C. over a three minute period of time due to the exothermic nature of the reaction. The reaction temperature remains at approximately 130° C. for the rest of the period (approximately 3 minutes).

In the above step, clay and/or organoclay particles (e.g., Clay 1, Clay 2, Clay 3, or some other suitable clay or organically-modified clay) are added after 6 minutes of the chain extension reaction step. The combined mixture is mixed further till the torque of the batch mixer reaches a plateau in approximately 9 minutes. During this step the temperature remains substantially stable at approximately 130° C. Upon completion of this step, a polyurethane nanocomposite is formed.

In the case where Clay 2 is utilized, intercalation of the organoclay particles with the polyol is avoided in Methods I and II in order to allow the —NCO groups to react only with the —CH₂CH₂OH groups present on the particles of Clay 2, thereby yielding clay-tethered polymer chains. The sample specimens for mechanical testing and characterization by X-ray are prepared by compression molding at 130° C. for five minutes.

Characterization:

The state of intercalation or exfoliation of nanoclay structures is investigated by wide angle X-ray diffraction (WAXD) method and transmission electron microscopy (TEM). A Rigaku X-ray diffractometer with wavelength, λ=1.54 ∈, tube voltage of 50 kV, and tube current of 150 mA is used to obtain WAXD patterns under reflection mode; the scanning rate was 5°/minute from 2θ=1.5° to 25°. TEM images are obtained from approximately 50 nanometer thick slices using TACNAI-12 TEM device operating at 120 kV.

The clay particles and associated tethered chains are separated from the bulk polymer by extraction in a Soxhlet extraction set up using tetrahydrofuran (THF) as a solvent. The extraction is carried out for 48 hours, by which time the residue reaches a constant weight. Ceramic thimbles with nominal pore size of 0.2 microns (μm) are used to retain the clay particles.

The clay-tethered polymer chains, in the residue, are freed up by subjecting the residue to reverse ion exchange reactions in a solution of lithium chloride (LiCl) in analytical grade tetrahydrofuran (THF). The free, soluble polymer chains are separated from the clay particles in a centrifuge and are used for molecular weight determination. The molecular weights of polymer chains are determined by Waters 510 gel permeation chromatography (GPC) system with triple detection scheme and a polystyrene standard.

The nanocomposites specimens, residue from Soxhlet extraction, and bulk polymer chains from the extract of Soxhlet extraction are characterized by Fourier-transform infrared spectroscopy (FT-IR) and differential scanning calorimetry (DSC). A Perkin Elmer FT-IR (Model 16PC) at a resolution of 4 cm⁻¹ is used to obtain the spectra of films of sample specimens placed between two KBr discs. The reaction between prepolymer and clay particles is also monitored by FT-IR. A Dupont DSC (Model DSC-2910) is used under a nitrogen atmosphere at a scanning rate of 20° C./minute over a temperature range of −50 to 250° C. to determine the glass transition temperature (T_{g}) of the polyurethane formed as noted above.

Tensile tests are performed using an Instron 5567 machine, following ASTM D 638, Type V method. The crosshead speed is 50 mm/minute. In each case, values of tensile properties are averaged over at least five measurements.

Morphology:

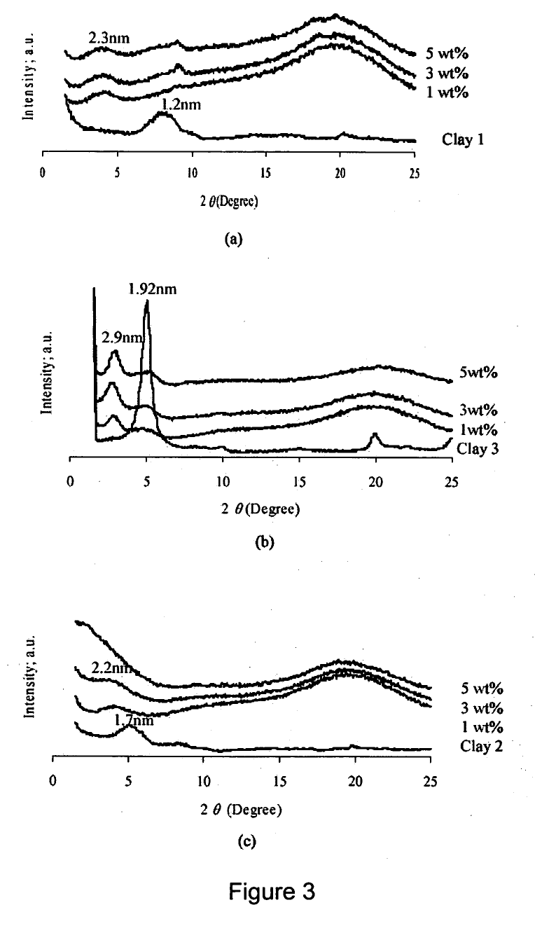

The state of dispersion of clay particles in polymer-clay composites formed via Method II is first analyzed using WAXD patterns, as is illustrated in FIGS. 3(a) to 3(c). The clay specimen of Clay 1 shows a broad diffraction peak at respectively 2θ=7.4°, d-spacing of approximately 1.2 nanometers (see FIG. 3(a)). The clay specimen of Clay 2 shows a broad diffraction peak at respectively 2θ=5.2°, d-spacing of approximately 1.7 nanometers (see FIG. 3(c)). On the other hand, a sharp peak at respectively 2θ=5° is observed for Clay 3 in FIG. 3(b) corresponding to a d-spacing of 1.92 nanometers.

The polymer-clay composites formed with Clay 1 show broad diffraction peaks at 2θ=3.75° (d-spacing of approximately 2.3 nanometers) in FIG. 3(a), while those formed with Clay 3 show sharp peaks at 2θ=3° (d-spacing of approximately 2.9 nanometers) in FIG. 3(b). In these cases, the presence of residual clay peaks indicates partial intercalation of clay layers by the polymer chains. The weak diffraction peaks present in FIG. 3(c) for composites containing 1 and 3 weight percent of Clay 2, where 2θ is equal to approximately 4°, indicate the presence of some intercalated clay structures with a d-spacing of approximately 2.2 nanometers. However, the Clay 2 nanocomposite with 5 weight percent Clay 2 shows no distinguishable peak for 2θ>1.5°. The absence of prominent peaks for the Clay 2 nanocomposite with 5 weight percent Clay 2 does not automatically guarantee that clay layers are fully exfoliated. Therefore, as will be discussed below, transmission electron microscopy is used to investigate the clay structures in composite materials.

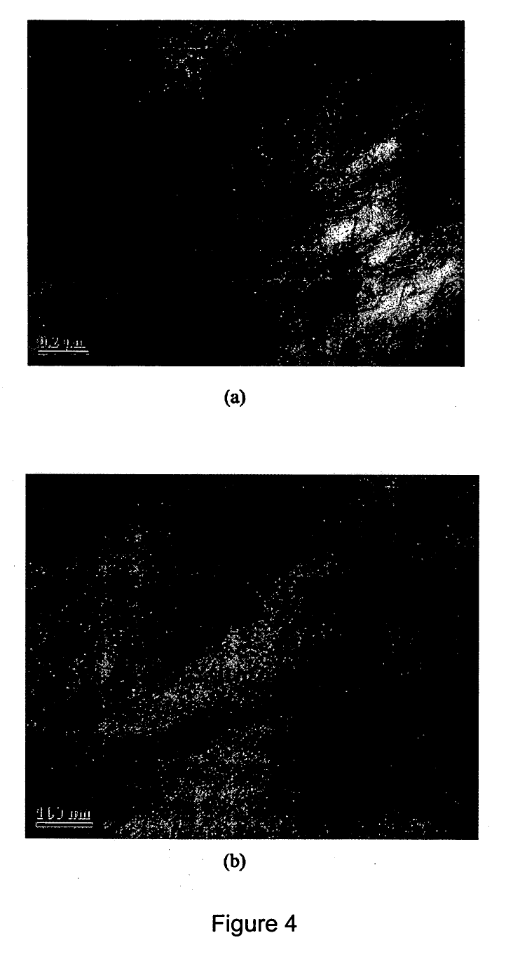

Turning to FIGS. 4(a) and 4(b), the results presented in FIGS. 4(a) and 4(b) refer to the polyurethane-clay composite formed via Method II, as discussed above, with weight percent Clay 2. In the other cases TEM images were not taken as the presence of original clay tactoids and partially intercalated tactoids were obvious from WAXD patterns (FIGS. 3(a) and 3(b)). As can be seen from FIGS. 4(a) and 4(b), a majority of the clay particles in the polyurethane-clay composite formed via Method II with 5 weight percent Clay 2 are indeed in an exfoliated state as is evident from the presence of a large number of single platelets shown in FIGS. 4(a) and 4(b).

Specifically, FIG. 4(a) shows that clay particles are dispersed well even in a small window of size (2 microns by 2 microns), although the clay particles were originally present as agglomerates of about 5 to about 20 microns. Thus, a size reduction in the agglomerates of at a factor of 2000 is achieved via Method II. Depending upon the starting size of the clay particles prior to agglomeration, Method II may even reduce the clay agglomerates of Clay 2 to individual particles, or agglomerates of just a few clay particles.

FIG. 4(b) reveals that some clay agglomerates remain as groups of approximately 10 individual particles, even though these groups are dispersed fairly well within the polymer. In addition, many clay platelets appear bent and, therefore, do not cause diffraction of X-rays. While not wishing to be bound to solely this theory, this may be the main reason for the absence of prominent clay peaks in FIG. 3(c). This is especially true in the case of the polyurethane-clay composite formed with 5 weight percent Clay 2.

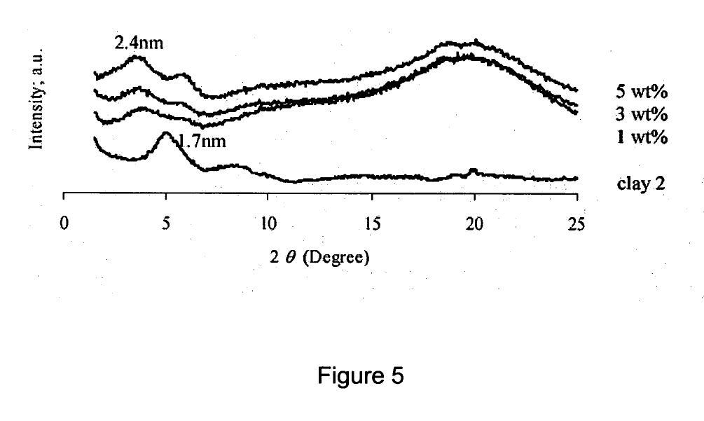

In polyurethane-clay composites prepared by Method I, the dispersion of clay particles is found to be very poor and the clay particles remained in an intercalated state, irrespective of the nature of treatment performed on the clay particles used to form the desired polyurethane-clay composite. Representative WAXD patterns of a polyurethane-clay composites containing 1, 3, and 5 weight percent Clay 2 that are formed via Method I (as discussed above), are illustrated in FIG. 5.

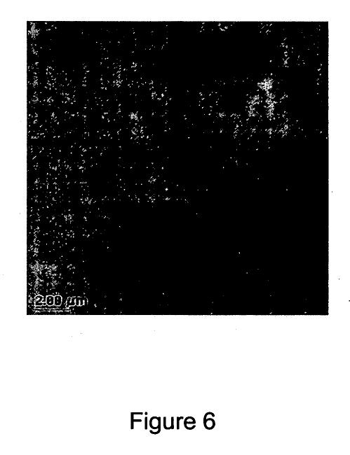

The intercalated clay structures for a polyurethane-clay composite that is formed via Method I and contains Clay 2 are also depicted in the TEM image sown in FIG. 6. Tactoids of approximately 3 microns in size are present in a polymer-clay composite containing 4 weight percent Clay 2 (formed via Method I—see FIG. 6). In view of FIGS. 5 and 6, Method I seems to yield only polymer-clay micro-composites.

On the other hand, FIG. 3(c) and FIG. 4 illustrate that the dispersion of clay particles is better in the polymer-clay composites formed using Method II, even in the face of increase clay content. Such observation is counterintuitive and contrary to what is/was commonly believed by those of ordinary skill in the art. That is, that the dispersion of clay particles becomes poor with the increase of clay content. This was confirmed by FT-IR and Soxhlet extraction.

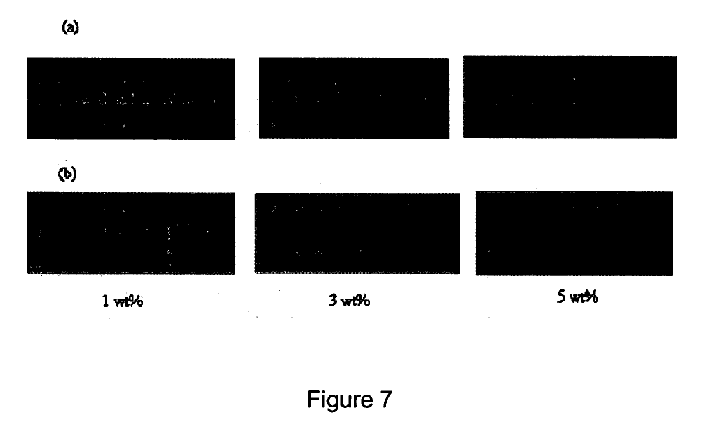

A ramification of excellent dispersion of clay particles is transparency of the resultant composites, as is illustrated in FIGS. 7(a) and 7(b). The optical clarity of exfoliated polymer-clay composites containing Clay 2 are preserved even at a clay content of 5 weight percent, while optical clarity is gradually lost in intercalated polymer-clay composites of Clays 1 and 3 with an increasing clay content.

As is shown in FIGS. 7(a) and 7(b), a 3 mm thick film formed from a polymer-clay composite is placed on a sheet of white paper with the word TRANSPARENT written on the sheet of paper. As is shown in the slides of FIG. 7(a), a 3 mm thick film formed form a polymer-clay composite of a polyurethane and Clay 2 (made in accordance with Method II), is transparent at all three clay weight percents. On the other hand, as is shown in the slides of FIG. 7(b), a 3 mm thick film formed form a polymer-clay composite of a polyurethane and Clay 1 (made in accordance with Method I), is only transparent at 1 weight percent, semi-transparent at 3 weight percent, and opaque at 5 weight percent.

Reactivity between Prepolymer and Clay:

The possibility of urethane linkage formation between the —CH₂CH₂OH functionalities of Clay 2 and —NCO end groups of the prepolymer chains is observed based upon the stretching of —NCO groups at 2270 cm⁻¹ in an FT-IR spectrum. For this purpose, 9 grams of Prepolymer and 0.5 grams of dried Clay 2 are mixed by hand at room temperature to yield a uniform mixture. A few drops of the Prepolymer-clay mixture is placed in a chamber formed by two KBr discs and a Teflon spacer and allowed to react at a temperature of 80° C. for a period of 60 minutes. This reaction corresponds to clay-polymer reaction that is utilized in Method I (as is discussed above), with relation to the formation of a polymer-clay composite with 5 weight percent of Clay 2.

Similar experiments are carried out in order to follow the chemical changes in the Prepolymer as it relates to the polymer-clay composites that are formed from mixtures of Prepolymer and Clay 1, and Prepolymer and Clay 3. The polymer-clay reaction process of Method I is chosen instead of Method II in order to exploit the much higher concentration of —NCO groups produced via Method I.

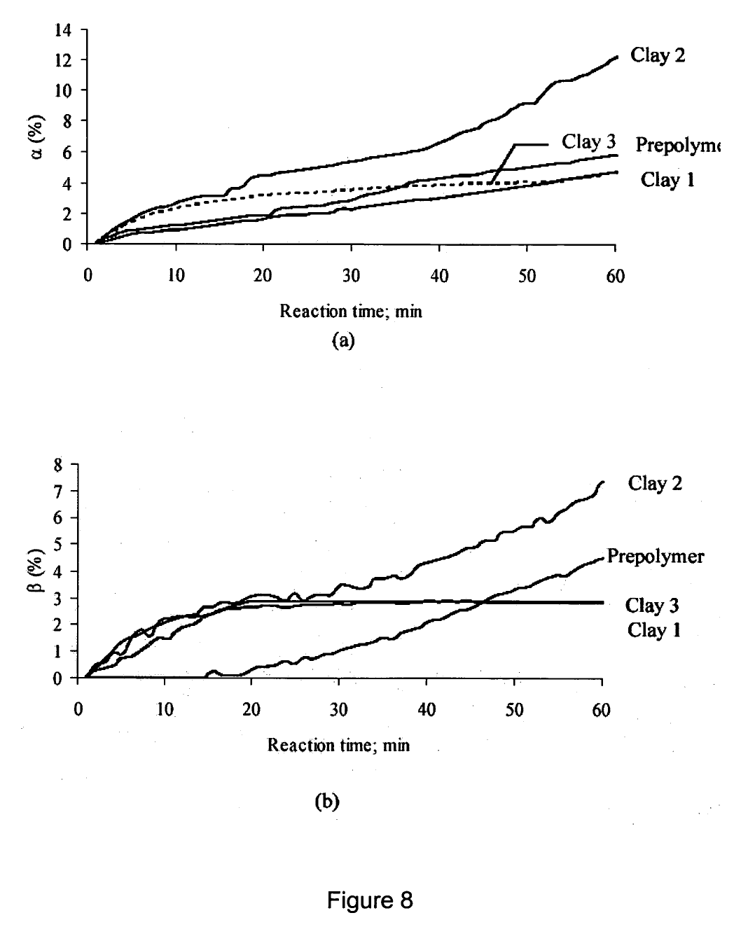

FIG. 8(a) shows how the conversion (a) of the —NCO group, defined as

$$α = \frac{{A}_{NCO , 0} - {A}_{NCO}}{{A}_{NCO , 0}}$$

changed with time over a period of 60 minutes. Here, A_{NCO} is the area under the peak at 2270 cm⁻¹ due to —NCO stretching at any time t and A_{NCO,0} is the value of initial area of —NCO peak. A constant value of the area under the peaks between 2860 and 2940 cm⁻¹ is due to —CH stretching (A_{CH}) during the reaction period illustrate that reactants do not flow out during the reaction. After 60 minutes, a is approximately 5% (or 0.05) to almost 6% (0.06) for Prepolymer, Prepolymer with Clay 1, and Prepolymer with Clay 3. This can be attributed to the presence of trace amounts of moisture on KBr discs and in the clay. The product of such reactions with moisture present is urea. The formation of allophanates and biurets can be ruled out in this situation as the reaction temperature is below 100° C.

In the case of Clay 2, a was found to be approximately 12% (0.12) (see FIG. 8a). This illustrate that —CH₂CH₂OH groups present in Clay 2 participated in the conversion of additional —NCO groups. An increase in the area under the carbonyl peak (A_{CO}) at 1733 cm⁻¹ is shown in FIG. 8(b) in the form of β versus time curves, where

$$β = \frac{{A}_{CO} - {A}_{CO} , 0}{{A}_{CO , 0}}$$

indicates that the reactions between —NCO and —CH₂CH₂OH groups yield urethane linkages. FIG. 8(b) also reveals non-zero values of β for Prepolymer and non-reactive clay particles, which can be attributed to —C═O groups in urea linkages arising from the reactions between —NCO groups and moisture.
Characterization of Nanocomposites by FT-IR:

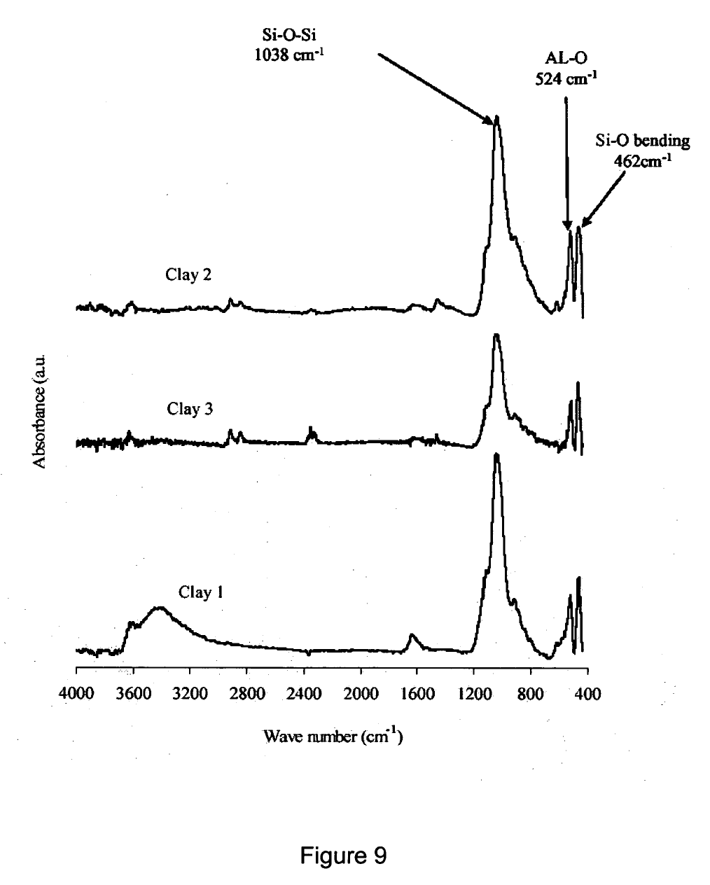

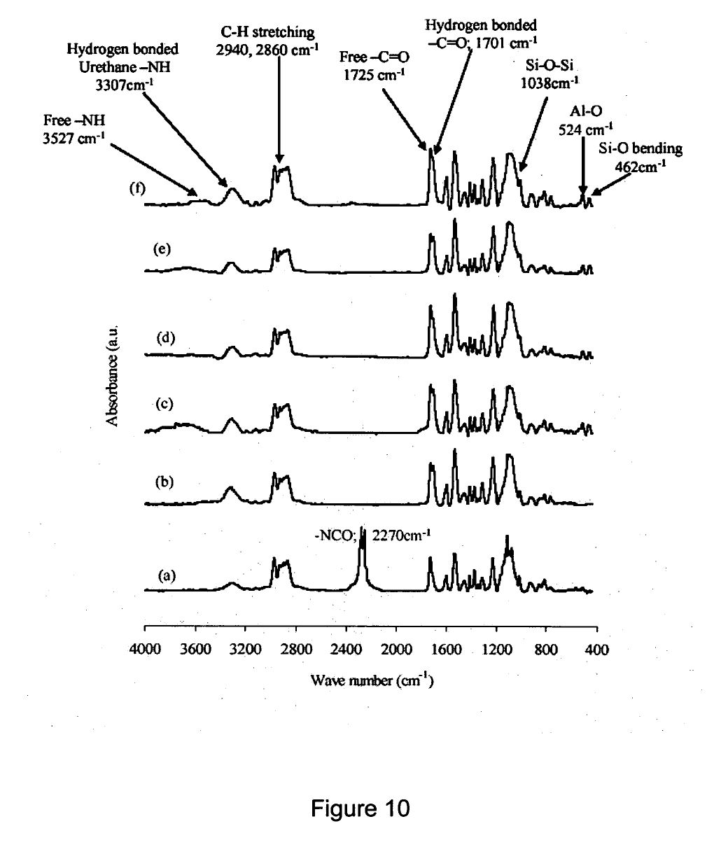

The FT-IR spectra of treated and untreated Clays 1, 2, and 3 are shown in FIG. 9. Turning to FIG. 10, FT-IR spectra of Prepolymer (spectrum (a)), fully chain-extended pristine polyurethane polymer (spectrum (b)), and polymer-clay composites containing 5 weight percent clay particles prepared by Method II (spectra (c), (d), and (e)) are presented in FIG. 10. Specifically, spectrum (c) is a polymer-clay composite formed using Clay 1, spectrum (d) is a polymer-clay composite formed using Clay 3, and spectrum (e) is a polymer-clay composite formed using Clay 2, all prepared by Method II as is discussed above. In FIG. 10, spectrum (f) is a spectrum of a polymer-clay composite formed using 5 weight percent Clay 2 prepared by Method I.

The characteristic bands associated with the stretching of Si—O—Si (1038 cm⁻¹) and Al—O (524 cm⁻¹) and bending of Si—O at 462 cm⁻¹ seen in FIG. 9 for Clays 1, 2, and 3 are also seen in the polymer-clay composite spectra depicted in FIG. 10 (see spectra (c) (f)). Note that CH-stretching (i.e., the peaks slightly to the left of 2800 cm⁻¹ in FIG. 9) is absent in the case of Clay 1, as this clay is organically treated. An additional peak at 3500 cm⁻¹ indicates absorbed moisture in the clay specimens.

The Prepolymer is characterized by a sharp —NCO peak at 2270 cm⁻¹, as shown in spectrum (a) of FIG. 10. The absence of —NCO peaks at 2270 cm⁻¹ in spectra (b) to (f) indicates the completion of chain extension reaction in each case. The hydrogen-bonded NH peaks at 3290 to 3307 cm⁻¹, free NH peaks at 3527 cm⁻¹, and carbonyl peaks at 1701 and 1725 cm⁻¹ indicate the presence of urethane linkages. Spectra (b) to (f) in FIG. 10 reveal that a majority of —NH groups in urethane linkages participated in hydrogen-bonding either with the —C═O group of the hard segment or with the ether linkages of the soft segment. The peaks for hydrogen-bonded —NH groups shifted from 3307 cm⁻¹ in pristine polyurethane to 3290 cm⁻¹ in the polymer-clay composites formed with Clay 2 and Clay 3. This indicates that a majority of the hydrogen-bonded —NH groups in these composites were associated with the ether linkages. An immediate impact of such soft-segment hydrogen bonding by the urethane —NH groups is the absence of appreciable, phase-separated hard segment domains, which in turn may exert negative impact on the mechanical properties.

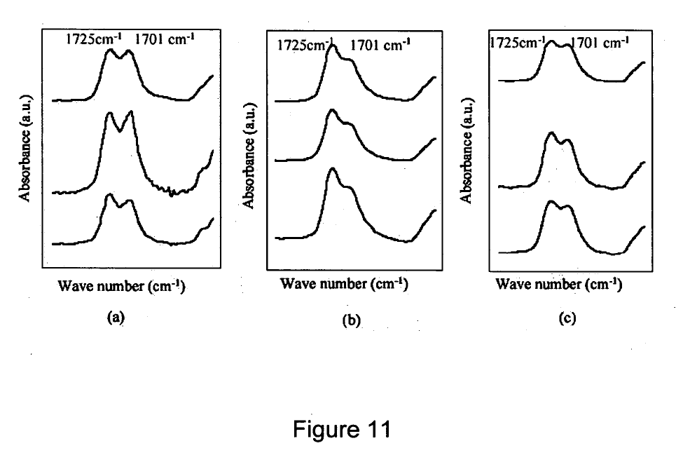

The carbonyl peaks—free at 1725 cm⁻¹ and hydrogen-bonded at 1701 cm⁻¹ appeared in pristine polyurethane and in the polymer-clay composites as evident in FIGS. 10 and 11. Table 2 below lists the ratio of areas under various characteristic peaks from FIG. 10 with respect to the area under the CH peak.

TABLE 2

| | | Polymer-Clay Composites | | | |
|---|---|---|---|---|---|
| | | Clay 1/ | | | |
| | Pristine | Method | Clay 3/ | Clay 2/ | Clay 2/ |
| Ratio | Polyurethane | II | Method II | Method II | Method I |
| A_{NH}/A_{CH} | 0.41 | 0.29 | 0.25 | 0.33 | 0.32 |
| A_{CO}/A_{CH} | 0.54 | 0.60 | 0.63 | 0.65 | 0.48 |
| A_{HCO}/A_{CO} | 1.03 | 0.77 | 0.78 | 0.98 | 0.48 |

As can be seen above, the values of A_{NH}/A_{CH} ratio are reduced significantly in the polymer-clay composites compared to the pristine polyurethane. Such a reduction can be interpreted in two possible ways. First, additional contribution of CH stretching may have come from the hydrocarbon chains of the organic treatment of the clays used in the polymer-clay composites. However, the number of —CH groups present in hydrocarbon chains of the organically treated clays are negligibly small compared to those derived from polyol and butanediol. In addition, a reduction in the value of the A_{NH}/A_{CH} ratio is observed for a polymer-clay composite formed using untreated Clay 1 indicates that the fraction of hydrogen-bonded —NH groups are reduced in the presence of clay particles. Second, the hydrogen-bonded NH peak shifts to 3290 cm⁻¹ in the polymer-clay composites in the spectra of the polymer-clay composites depicted in FIG. 10. Thus, a substantially large fraction of the —NH groups were hydrogen-bonded to ether linkages, instead of to the —C═O groups of the hard segments.

FIG. 11 highlights the carbonyl peaks of polymer-clay composites formed from a polyurethane and Clay 2 (spectra (a)), a polyurethane and Clay 3 (spectra (b)), and a polyurethane and Clay 1 (spectra (c)). All of the polymer-clay composites are formed via Method II, as is discussed above. Table 2 lists the ratio of values of the area under the peaks of hydrogen-bonded carbonyl groups at 1701 cm⁻¹. (A_{HCO}) and free carbonyl groups at 1725 cm⁻¹ (A_{CO}). It is found that the largest value of A_{HCO}/A_{CO} ratio is found in the case of pristine polyurethane and lowest in the case of the polymer-clay composite formed with Clay 1. This indicates that the presence of Clay 1 particles hindered hydrogen bonding between carbonyl and —NH groups of the hard segments. In view of this, however, it is surprising to find that the value of A_{HCO}/A_{CO} for Clay 2/Method II is substantially higher than the same value for the other polymer-clay composites, and is very close to that of pristine polyurethane.

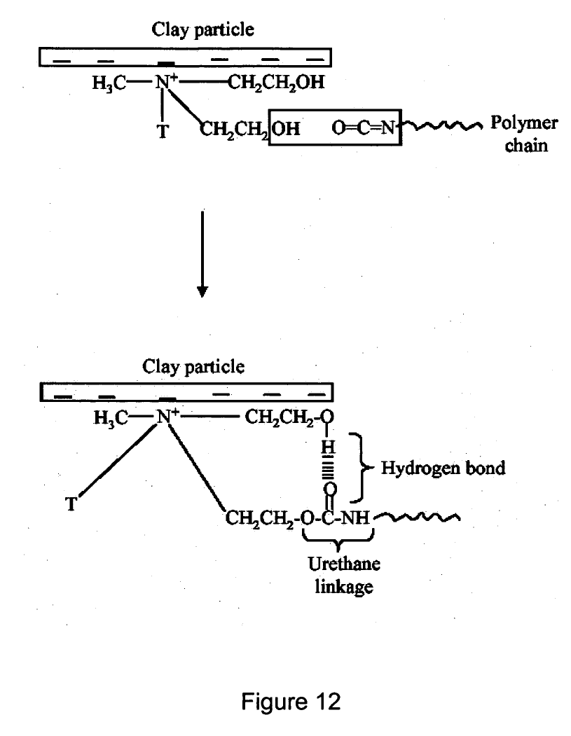

While not wishing to be bound to any particular theory, one theory that explains the origin of the additional hydrogen-bonded carbonyl groups found in the polymer-clay composite formed from Clay 2 using Method II in contrast to those of Clay 1/Method II, Clay 3/Method II and Clay 2/Method I may be as follows. Some polymer chains ending with —NCO groups diffused into the vicinity of the clay galleries during composite preparation and reacted with the —CH₂CH₂OH group of the quaternary ammonium ions to produce urethane linkage, —CO—NH—. The urethane linkages, in turn, formed hydrogen bonds with the second —CH₂CH₂OH group residing on the same quaternary ammonium ion, as depicted in FIG. 12.

Another possibility is that —C═O groups of the hard segments of polyurethane chains residing in the vicinity of one or more clay particles form hydrogen bonds with the —CH₂CH₂OH groups of the quaternary ammonium ions. The fine dispersion of clay particles, as revealed from TEM images in FIG. 4, may have promoted such interactions. Both scenarios are supported by much lower values of A_{NH}/A_{HCO} ratio of approximately 2.4 in Clay 2, compared to the ratio of approximately 3.2 for pristine polyurethane.

However, it is not yet not possible to determine the fraction polymer chains reacted with the clay particles from the FT-IR spectra itself as depicted in FIGS. 10 and 11. As there is no —CH₂CH₂OH group on quaternary ammonium ions in Clay 3 and no quaternary ammonium ions at all in Clay 1, the reactions between clay and polymer chain was not possible in these cases.

Spectrum (f) in FIG. 10 shows an FT-IR spectra of a polymer-clay composite produced using Method I (as is discussed above) that contains 5 weight percent Clay 2. Two differences are readily apparent when spectrum (f) of FIG. 10 is compared to spectrum (e) of FIG. 10. First, the peak height attributed to hydrogen-bonded CO (1701 cm⁻¹) is much shorter in spectrum (e) (i.e., in material prepared by Method II). Second, the ratio A_{CO}/A_{CH} is much smaller for spectrum (f) than for spectrum (e). In addition, the ratio A_{HCO}/A_{CO} is substantially smaller, 0.48 compared to 1.03 for pristine polyurethane and 0.98 for the polymer-clay composite using Clay, the composite being prepared by Method II (see Table 2). These values indicate that hydrogen bonding of free polymer chains via urethane linkages with the —CH₂CH₂OH groups of quaternary ammonium ions is greatly reduced in composites prepared by Method I. The TEM image of FIG. 6 depicting that clay particles are in a poorly dispersed state, also supports this statement.

The scenario presented in FIG. 12, i.e., originating from clay-tethering reactions and subsequent hydrogen bonding suggest that it is not clear as to what fraction of the hydrogen-bonded carbonyl groups arise therefrom.

Clay-Yethered Polymer Chain Residues:

The residue in Soxhlet thimble, expressed as percentage by weight of the original amount of the composite specimen taken for extraction, is presented in Table 3 as shown below.

TABLE 3

| | | | Weight | |
|---|---|---|---|---|
| | Clay | | Average | |
| | Content | Residue | Molecular | Polydispersity |
| Material | (wt %) | (wt %) | Weight (Mw) | Index (Mw/Mn) |
| Pristine | 0 | 0 | 63,000 | 3.2 |
| Polyurethane | | | | |
| Polymer-Clay | 1 | 0.8 | 75,000 | 2.6 |
| Composite (Clay | 3 | 2.5 | 65,000 | 2.2 |
| 1/Method II) | 5 | 4 | 61,000 | 2.4 |
| Polymer-Clay | 1 | 2 | 64,000 | 2.8 |
| Composite (Clay | 3 | 4 | 61,000 | 3.0 |
| 3/Method II) | 5 | 6 | 60,000 | 3.0 |
| Polymer-Clay | 1 | 2 | 85,000 | 4.1 |
| Composite (Clay | 3 | 6 | 75,000 | 3.5 |
| 2/Method II) | 5 | 8 | 82,000 | 3.7 |
| Polymer-Clay | 1 | 2 | 31,000 | 1.5 |
| Composite (Clay | 3 | 7 | 29,000 | 1.6 |
| 2/Method I) | | | | |

The residue is expected to indicate the extent of clay-tethered polymer chains, with the exception of a very small amount of polymer chains physically adsorbed on the clay particles.

A point to note here, is that Methods I and II presented very different limits for the maximum amounts of clay-tethered polymer chains expected with Clay 2. In Method I, only short chain prepolymer (Mn of approximately 2800) are involved in clay-polymer reactions, while in Method II, extended chain polymer (Mn of approximately 20,000) participated in polymer-clay reactions. Therefore, approximately 10 times greater polymer mass was tethered to Clay 2 in Method II than in Method I via a single polymer-clay reaction. The compositions presented in Table 1 reveal that 2.36 grams organic-free clay, 1.14 grams quaternary ammonium ion, 20.74 grams of diphenylmethane-4,4′-diisocyanate (MDI), 42.33 grams of polyol (polyetherpolyol), and 3.46 grams of 1,4-butanediol (BD) are used to make 70 grams of polymer-clay composite. As the equivalent weight of the quaternary ammonium ion is 180.4 grams, there are altogether 0.0063 equivalents of —CH₂CH₂OH groups available for polymer-clay tethering. This leads to the formation of 0.0063 equivalents of clay-tethered polymer chains, which yields approximately 18 grams via Method I and approximately 126 grams via Method II. In these calculations, a polymer chain is assumed to react only once with a quaternary ammonium ion, even though there are two —CH₂CH₂OH groups per quaternary ammonium ion. A comparison of the amounts of residue obtained in Soxhlet extraction step in Table 3 reveals that in the case of a polymer-clay composite containing 5 weight percent Clay 2, only about 4 weight percent of the —CH₂CH₂OH groups originally present in the clay reacted in Method II, while 35 weight percent reacted in Method I. In view of the data presented above and the fact that approximately 20% of the cations in montmorillonite clay are derived from the broken bonds located at the edges, all clay-tethering reactions in Method II and a majority in Method I can be considered to occur with the quaternary ammonium ions located at the edges of the clay particles. Note that the residues for Clay 1 and Clay 3 were almost the same as the amounts of clay originally used.

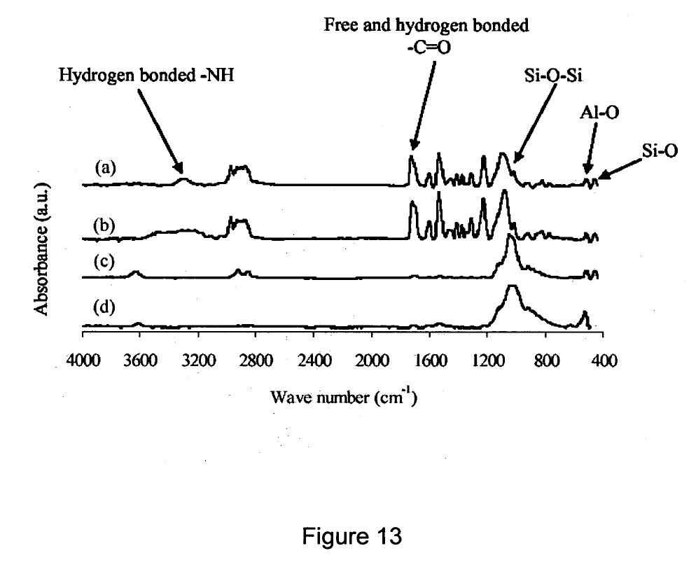

The residues collected from the Soxhlet thimble are characterized by FT-IR and differential scanning calorimetry (DSC). It can be seen from FT-IR spectra in FIGS. 13, that the residue containing Clay 2 contains both the characteristic peaks of —C═O groups at 1725 cm⁻¹, hydrogen bonded —NH groups at 3307 cm⁻¹, and Si—O—Si stretching at 1038 cm⁻¹, indicating the presence of polyurethane chains and clay particles respectively in the residue. Spectra (c) and (d) in FIG. 13, show only the prominent Si—O—Si stretchings of the clay; a peak of very small height is observed at 1733 cm⁻¹ indicating that only a trace amount of polyurethane chains are associated with the residue, probably by physical adsorption on the clay particle surfaces.

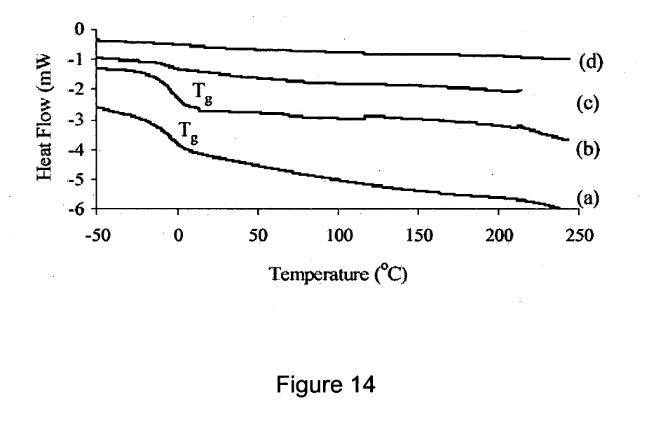

The DSC thermograms of residue from clay 2 (see thermograms (a) and (b) in FIG. 14) show thermal transitions associated with polyurethane chains. The residue of Method I gives a T_{g} of −1.5° C. and that of Method II a T_{g} of −2.5° C. The same transition was not observed in the case of Clay 1 (see thermogram (d) in FIG. 14). A small transition is seen for Clay 3 between −6° C. and 2° C. (see thermogram (c) in FIG. 14). These observations, along with the evidence from FT-IR, establish that a substantial amount of polyurethane chains are tethered to clay particles in the polymer-clay composites formed with Clay 2 and almost none in the polymer-clay composites that contain Clays 1 and 3.

Molecular Weight:

The molecular weights of soluble polyurethane chain extracts are presented in Table 3. It is observed that the molecular weights of soluble chains from Clay 1 and Clay 3 by Method II are closer to pristine polyurethane. The polydispersity index of materials from Method II is also comparable to that of pristine polyurethane. However, the molecular weight of the soluble polymer from Method I is much lower than in Method II, e.g., Mw=31,000 for Method I versus an Mw=85,000 for Method II in the case of a polymer-clay composite containing 1 weight percent of Clay 2.

In Method II, it is anticipated that the molecular weight of clay-free polyurethane chains would not show dependence on the nature of the clay particles, first due to small clay loading and second due to the fact that chain extension reactions between butanediol and prepolymer are carried out before the clay particles are added. One possible cause of such higher molecular weights, especially for higher loaded polymer-clay composites formed with Clay 2 may be the formation of allophanates. This allophanate formation is associated with branching, cross-linking, or both and may contribute to some residues in Soxhlet extraction.

Clay 2 particles are added after 6 minutes of catalyzed chain extension reactions. Therefore, at the beginning of the chain extension reaction, the ratio of concentration of isocyanate groups to —OH groups is 1.07, which may cause exposed chain extended polymers to undergo allophanate and biuret formation especially as the temperature increases to 130° C.

Thermal Analysis:

The thermal properties of composite materials are given in Table 4 below.

TABLE 4

| | | | | T_{g} (° C.) of |
|---|---|---|---|---|
| Material | Clay (wt %) | T_{g} (° C.) | Tₘ (° C.) | Residue |
| Pristine | 0 | −6 | 140 | −6 |
| Polyurethane | | | | |
| Polymer-Clay | 1 | −3 | 138 | −4 |
| Composite (Clay | 3 | −2 | 140 | −4 |
| 1/Method II) | 5 | −2 | 146 | −3 |
| Polymer-Clay | 1 | −2 | 143 | −4 |
| Composite (Clay | 3 | −2 | 141 | −4 |
| 3/Method II) | 5 | −4 | 146 | −4 |
| Polymer-Clay | 1 | −3 | 141 | −4 |
| Composite (Clay | 3 | −2 | 142 | −4 |
| 2/Method II) | 5 | −1 | 147 | −6 |
| Polymer-Clay | 1 | −5 | 134 | −12 |
| Composite (Clay | 3 | −7 | 133 | −14 |
| 2/Method I) | 5 | −10 | 134 | −22 |

The soft segments of prepolymer and pristine polyurethane showed glass transition at respectively −28° C. and −6° C. It is evident that the glass transition temperature of soft segment in polymer-clay composites prepared by Methods I and II changed only slightly due to the presence of the clay particles. The melting transitions, corresponding to the hard-segment phases, yield melting temperatures (Tₘ) of 140° C. for pristine polyurethane; 147° C. for a polymer-clay composite containing 5 weight percent Clay 2, prepared by Method II; and 134° C. for a polymer-clay composite containing 5 weight percent Clay 2, prepared by Method I. However, the value of enthalpy associated with melting in each case is small.

The values of the T_{g} of soluble polymer chains from Soxhlet extraction are also given in Table 5 below.

TABLE 5

| | | | | Strain |
|---|---|---|---|---|
| | Clay | | Maximum | at Break |
| Material | (wt %) | Modulus (MPa) | Stress (MPa) | (%) |
| Pristine Polyurethane | 0 | 1.4 ± 0.1 | 4.7 ± 0.04 | 2100 |
| Polymer-Clay | 1 | 1.1 ± 0.05 | 5.2 ± 0.1 | 2800 |
| Composite (Clay | 3 | 1.3 ± 0.06 | 4.9 ± 0.2 | 2500 |
| 1/Method II) | 5 | 1.4 ± 0.04 | 3.6 ± 0.1 | 2000 |
| Polymer-Clay | 1 | 1.5 ± 0.1 | 7.2 ± 0.7 | 2850 |
| Composite (Clay | 3 | 1.9 ± 0.05 | 7.6 ± 0.1 | 2700 |
| 3/Method II) | 5 | 2.4 ± 0.3 | 5.1 ± 0.1 | 2500 |
| Polymer-Clay | 1 | 1.7 ± 0.15 | 9.7 ± 0.2 | 2500 |
| Composite (Clay | 3 | 2.3 ± 0.11 | 11.2 ± 0.3 | 2000 |
| 2/Method II) | 5 | 3.0 ± 0.06 | 12.8 ± 0.6 | 1800 |
| Polymer-Clay | 1 | 0.5 ± 0.05 | 2.6 ± 0.03 | 2200 |
| Composite (Clay | 3 | 0.6 ± 0.05 | 1.0 ± 0.03 | 2300 |
| 2/Method I) | 5 | 0.5 ± 0.02 | 0.5 ± 0.02 | 4600 |

Again, the soft segment T_{g} values of soluble polymer chains from Method II are seen to be insensitive to the clay content and are in the same neighborhood as those of pristine polyurethanes. Recall that clay particles are added in Method II after 6 minutes of chain extension reactions with butanediol. The soluble polymer from Method I, on the other hand, show significant reduction in the values of T_{g} (see Table 4) in line with a much reduced molecular weight of soluble polymer reported in Table 3.
Role of Viscosity on Clay Particle Dispersion:

The dramatic differences in the state of dispersion of clay particles in composites prepared by Method I and Method II (see FIGS. 4 and 6) can now be examined in the light of shear viscosity of the polymer responsible for clay particle dispersion. For this purpose, the values of complex viscosity (η*) of prepolymer and chain extended polymers were determined in APA2000 Alpha Technologies rheometer respectively at 80° C. and 130° C. with a strain of 0.14% and frequency of 10 rad/s. Recall that in Method I clay particles are dispersed in a prepolymer at 80° C. In Method II, clay particles are mixed with chain-extended polymer at 130° C. to imitate the temperature rise observed during nanocomposites preparation. The chain extended polymers are prepared following the recipe given in Table 1 for a polymer-clay composite containing 5 weight percent Clay 2. For this purpose, 1 mole of prepolymer is mixed with 0.93 moles of butanediol and polymerized at 130° C. in the rheometer and the value of η* is noted at the end of a 10 minute period. The prepolymer is found to have a viscosity of 500 Pa.s at 80° C. compared to a viscosity of 4500 Pa.s at 130° C. of the chain-extended polymer. Thus the level of shear stress available in Method II for particle dispersion is approximately an order of magnitude greater than in Method I. Such a disparity in the level of shear stress raises the question of whether only the shear stress is responsible for particle dispersion. Poor dispersion observed in polymer-clay composites containing Clays 1 and 3, even in Method II, discounts such possibility. In view of this, the chemistry of clay-particle tethering must play an important role in achieving the better particle dispersion observed with Clay 2.

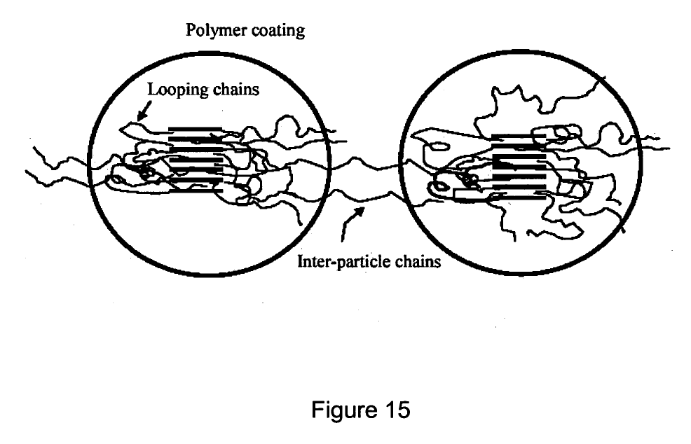

The poor dispersion of clay particles observed in Method I (FIGS. 5 and 6) is believed to be due to the fact that the level of shear stress is low and shear-induced delamination of clay particles is small. The concentration of —NCO groups for clay-polymer reactions is the highest in Method I and prepolymer chains are permitted to react with the —CH₂CH₂OH groups on Clay 2 for a period of 1 hour at 80° C. Thus, it is quite likely that a large fraction of prepolymer chains in the neighborhood of clay particles readily tether to the clay particles using both end —NCO groups, thus forming a coating of polymer layers around the clay particles (see FIG. 15). Consequently, the clay particles, completely coated by the tethered-polymer chains, do not undergo shearing deformation in the chain extension step and remain as agglomerates. In addition, the 0.295 weight percent moisture in the clay also has an opportunity to react with the prepolymer chains, thus forming urea and effectively eliminating many prepolymer chains from participation in chain extension reactions with butanediol at a later stage. A reduction in molecular weight, as is reported in Table 3, and a reduction in the value of A_{HCO}/A_{CO} in Table 2, support the fact that many prepolymer chains are tethered to clay particles by both —NCO end groups.

Tensile Properties:

The values of tensile strength, modulus, and elongation at break of composites are presented in Table 5 above. The materials prepared by Method I performed poorly, as is expected in view of lower molecular weight reported in Table 3 and poor dispersion of clay particles seen in FIGS. 5 and 6.

Of the materials prepared by Method II, the polymer-clay composite containing Clay 2 showed higher values of modulus and tensile strength for all three clay loadings. These properties remained insensitive to clay content in polymer-clay composites containing Clay 1, though the polymer-clay composite containing 1 weight percent Clay 3 show improvements in both stress and strain. In the case of a polymer-clay composites containing 5 weight percent Clay 2/Method II, the modulus and the tensile strength reached respectively 3 MPa and 12.8 MPa, which are respectively 110% and 160% higher than pristine polyurethane. An increase in modulus from 1.5 MPa to 2.4 MPa is seen with the increase of content of Clay 1, but the values of stress and strain at break decrease from 7.6 MPa to 5.1 MPa and from 2850% to 2500%, respectively.

It is clear that nanocomposites of Clay 2 show the best improvement in mechanical properties due to exfoliation of clay particles and clay-polymer tethering. Polyurethane-clay composites of reactive clay particles prepared by bulk polymerization methods in accordance with the present invention can be achieved when the clay particles are tethered to polymer chains via clay-polymer reactions and are dispersed to the scale of individual clay layers. This is true for better dispersions of clay particles The best results in terms of nanoclay exfoliation are achieved via large values of shear stress during clay-polymer mixing. The reaction between —CH₂CH₂OH functional groups on quaternary ammonium ions and —NCO groups on polymer chains is established by FT-IR. Reacting the clay with the prepolymer does not produce good clay particle dispersion, first due to low values of shear stress involved in clay-polymer mixing and second due to a likely scenario whereby prepolymer chains are tethered to clay particles with both ends and coated the clay particles.

In another embodiment, the clay and/or organo clays of the present invention can be replaced by any suitable nanoparticles that will react with and/or tether to the —NCO groups present in a polyurethane polymer. Using the production methods disclosed herein (e.g., Method II), polymer-nanoparticle composites can be formed. Suitable nanoparticles include, but are not limited to, functionalized carbon nanotubes, functionalized carbon nanofibers, and silane-treated silica particles. In the case where the nanoparticles are functionalized, the nanoparticles are functionalized with -OH groups and/or —NH groups.

In one embodiment, the nanoparticles used in the present invention have a diameter (e.g., in the case where a silane-treated silica is utilized) and/or length (e.g., in the case where one or more of carbon fibers and/or carbon nanotubes are utilized) in the range of about 1 nanometer to about 50,000 nanometers, or from about 10 nanometers to about 25,000 nanometers, or from about 20 nanometers to about 20,000 nanometers, or from about 30 nanometers to about 10,000 nanometers, or from about 40 nanometers to about 5,000 nanometers, or from about 50 nanometers to about 2,500 nanometers, or even from about 60 nanometers to about 1,250 nanometers.

For the purposes of reactivity and/or tethering ability with one or more isocyanate groups present in the polyurethane polymers utilized in the present invention, the terms organically modified and functionalized can be used interchangeably.

Although the invention has been described in detail with particular reference to certain embodiment detailed herein, other embodiments can achieve the same results. Variations and modifications of the present invention will be obvious to those skilled in the art and the present invention is intended to cover in the appended claims all such modifications and equivalents.

What we claim is:

1. A process for producing a polymer-particle composite, comprising the steps of:
(A) preparing a polyurethane polymer; and
(B) mixing the polyurethane polymer with particles of at least one modified and/or functionalized compound,
wherein the at least one modified and/or functionalized compound contains at least one site that will react with one or more isocyanate groups contained in the polyurethane polymer, and
wherein particles of the at least one modified and/or functionalized compound become tethered to one or more isocyanate groups of the polyurethane polymer thereby yielding a polymer-particle composite.

2. The process of claim 1, wherein Step (A) includes the step of subjecting a urethane prepolymer and/or a low molecular weight polyurethane to a chain extension reaction.

3. The process of claim 4, wherein chain extension reaction step comprises reacting the urethane prepolymer and/or a low molecular weight polyurethane with at least one diol and at least one catalyst.

4. The process of claim 3, wherein the at least one diol is 1,4-butanediol.

5. The process of claim 3, wherein the at least one catalyst is dibutyltinlaureate.

6. The process of claim 1, wherein Step (A) comprises reacting at least one organic polyol with at least one diisocyanate.

7. The process of claim 5, wherein the at least one organic polyol is polyetherpolyol and the at least one diisocyanate is diphenylmethane-4,4′-diisocyanate.

8. The process of claim 1, wherein the at least one modified and/or functionalized compound is selected from one or more organically modified clays, functionalized carbons nanotube, functionalized carbon nanofibers, silane-treated silica particles, or combinations of two or more thereof.

9. The process of claim 8, wherein the functionalized compounds are functionalized via the inclusion of and/or an increase in the number of —OH groups and/or —NH groups present in the functionalized compounds.

10. The process of claim 8, wherein the at least one modified and/or functionalized compound is at least one organically modified clay that has been organically modified with a quaternary ammonium salt.

11. The process of claim 1, wherein particles of the at least one modified and/or functionalized compound have a particle diameter and/or length in the range of about 1 nanometer to about 50,000 nanometers.

12. The process of claim 11, wherein particles of the at least one modified and/or functionalized compound have a particle diameter and/or length in the range of about 50 nanometers to about 2,500 nanometers.

13. The process of claim 12, wherein particles of the at least one modified and/or functionalized compound have a particle diameter and/or length in the range of about 60 nanometers to about 1,250 nanometers.

14. A process for producing a polymer-clay composite, comprising the steps of:
(A) preparing a polyurethane polymer; and
(B) mixing the polyurethane polymer with particles of at least one organically modified clay,
wherein the at least one organically modified clay contains at least one site that will react with one or more isocyanate groups contained in the polyurethane polymer, and
wherein particles of the at least one organically modified clay become tethered to one or more isocyanate groups of the polyurethane polymer thereby yielding a polymer-clay composite.

15. The process of claim 14, wherein Step (A) includes the step of subjecting a urethane prepolymer and/or a low molecular weight polyurethane to a chain extension reaction.

16. The process of claim 15, wherein chain extension reaction step comprises reacting the urethane prepolymer and/or a low molecular weight polyurethane with at least one diol and at least one catalyst.

17. The process of claim 14, wherein Step (A) comprises reacting at least one organic polyol with at least one diisocyanate.

18. The process of claim 17, wherein the at least one organic polyol is polyetherpolyol and the at least one diisocyanate is diphenylmethane-4,4′-diisocyanate.

19. The process of claim 14, wherein the at least one organically modified clay is a Montmorillonite clay modified with a quaternary ammonium salt.

20. The process of claim 14, wherein particles of the at least one organically modified clay have a particle diameter and/or length in the range of about 1 nanometer to about 20,000 nanometers.

21. The process of claim 20, wherein particles of the at least one organically modified clay have a particle diameter and/or length in the range of about 30 nanometers to about 2,500 nanometers.

22. The process of claim 21, wherein particles of the at least one organically modified clay have a particle diameter and/or length in the range of about 50 nanometers to about 500 nanometers.

23. The process of claim 22, wherein particles of the at least one organically modified clay have a particle diameter and/or length in the range of about 60 nanometers to about 250 nanometers.

24. A polymer-particle composite comprising:
at least one polyurethane polymer; and
particles of at least one modified and/or functionalized compound,
wherein the particles of at least one modified and/or functionalized compound contain at least one site that will react with one or more isocyanate groups contained in the polyurethane polymer, and
wherein the particles of at least one modified and/or functionalized compound become tethered to one or more isocyanate groups of the polyurethane polymer thereby yielding the polymer-particle composite.

25. The polymer-particle composite of claim 24, wherein the at least one modified and/or functionalized compound is selected from one or more organically modified clays, functionalized carbons nanotube, functionalized carbon nanofibers, silane-treated silica particles, or combinations of two or more thereof.

26. The polymer-particle composite of claim 25, wherein the functionalized compounds are functionalized via the inclusion of and/or an increase in the number of —OH groups and/or —NH groups present in the functionalized compounds.

27. The polymer-particle composite of claim 25, wherein the at least one modified and/or functionalized compound is at least one organically modified clay that has been organically modified with a quaternary ammonium salt.

28. The polymer-particle composite of claim 24, wherein particles of the at least one modified and/or functionalized compound have a particle diameter and/or length in the range of about 1 nanometer to about 50,000 nanometers.

29. The polymer-particle composite of claim 28, wherein particles of the at least one modified and/or functionalized compound have a particle diameter and/or length in the range of about 50 nanometers to about 2,500 nanometers.

30. The polymer-particle composite of claim 29, wherein particles of the at least one modified and/or functionalized compound have a particle diameter and/or length in the range of about 60 nanometers to about 1,250 nanometers.

31. A polymer-clay composite comprising:
at least one polyurethane polymer; and
at least one organically modified clay composition,
wherein the at least one organically modified clay composition contains at least one site that will react with one or more isocyanate groups contained in the polyurethane polymer, and
wherein the at least one organically modified clay composition becomes tethered to one or more isocyanate groups of the polyurethane polymer thereby yielding the polymer-clay composite.

32. The polymer-clay composite of claim 31, wherein the at least one organically modified clay is a Montmorillonite clay modified with a quaternary ammonium salt.

33. The polymer-clay composite of claim 32, wherein particles of the at least one organically modified clay have a particle diameter and/or length in the range of about 1 nanometer to about 20,000 nanometers.

34. The polymer-clay composite of claim 33, wherein particles of the at least one organically modified clay have a particle diameter and/or length in the range of about 30 nanometers to about 2,500 nanometers.

35. The polymer-clay composite of claim 34, wherein particles of the at least one organically modified clay have a particle diameter and/or length in the range of about 50 nanometers to about 500 nanometers.

36. The polymer-clay composite of claim 35, wherein particles of the at least one organically modified clay have a particle diameter and/or length in the range of about 60 nanometers to about 250 nanometers.
